(19) United States
(12) Patent Application Publication
(10) Pub. No.: US 2009/0086348 A1
(43) Pub. Date: Apr. 2, 2009

(54) System for simultaneously turning and tilting an array of mirror concentrators

(76) Inventor: Jinchun Xie, Redwood City, CA (US)

Correspondence Address: SCHEIN & CAI LLP, 111 W. ST. JOHN ST., SUITE 1250, SAN JOSE, CA, 95113, US

(21) Appl. No.: 12/286,692

(22) Filed: Sep. 30, 2008

Related U.S. Application Data
(60) Provisional application No. 60/997,254, filed on Oct. 1, 2007.

(51) Int. Cl. G02B 7/198

(52) U.S. Cl. 359/853

(57) ABSTRACT

A system for simultaneously turning and tilting an array of mirror concentrators includes a first stepper motor operable to drive a first lead screw coupled to each row of the array of mirror concentrators, the rotation of the first lead screw simultaneously turning the rows of the array about a first axis thereof, and a second stepper motor operable to drive a second lead screw coupled to each mirror concentrator of each row, the rotation of the second lead screw simultaneously tilting each mirror concentrator about a second axis thereof.

### CROSS REFERENCE TO RELATED APPLICATIONS

The present application claims priority under 35 U.S.C. 119(e) from provisional patent application Ser. No. 60/997,254, entitled “An Array of Mirror Concentrators of Solar Cell Simultaneously Turned and Tilted by Only Two Motors”, filed on Oct. 1, 2007, the disclosure of which is herein incorporated by reference in its entirety.

### BACKGROUND OF THE INVENTION

The present invention relates generally to reflector array positioning systems and more particularly to a system for simultaneously turning and tilting an array of mirror concentrators.

Reflector array positioning systems are well known in the art. For example, U.S. Pat. No. 6,042,240 entitled “Adjustable Three Dimensional Focal Length Tracking Reflector Array” discloses a reflector positioned in orbit about a celestial body to focus sunlight on objects such as space debris to heat up and vaporize such debris. The reflector includes a plurality of units in an array, with each of the units including a plurality of subunits. Each of the units rotates about a first axis and each of the subunits is tiltable about a second axis which is perpendicular to the first axis. A reflecting surface is mounted on each of the subunits such that the reflecting surface rotates with its respective unit and tilts with its respective subunit. Each of the units and each of the subunits is independently controllable.

U.S. Patent Application Publication No. 2004/0074490 entitled “Solar Energy Reflector Array” discloses a heliostat comprising a reflector element and a carrier that is arranged to support the reflector element above a ground plane. A drive means is arranged to impart pivotal drive to the carrier about a fixed, first axis that is, in use of the heliostat, disposed substantially parallel to the ground plane. The heliostat further comprises a means mounting the reflector element to the carrier in a manner which permits pivotal movement of the reflector element with respect to the carrier and about a second axis that is not parallel to the first axis.

Known reflector array positioning systems suffer the disadvantage that they are complex and thus expensive to manufacture and deploy. What is needed therefore is a system for simultaneously turning and tilting an array of mirror concentrators that is of relatively simple construction and inexpensive to manufacture and deploy.

### SUMMARY OF THE INVENTION

The system for simultaneously turning and tilting an array of mirror concentrators of the invention turns and tilts the array of mirror concentrators simultaneously and with the same angle such that the mirror concentrators precisely follow the trajectory of the sun as it traverses the sky. The array of mirror concentrators is generally arranged in n rows with each row having m mirror concentrators. A first stepper motor turns all of the rows of mirror concentrators simultaneously about a first axis by means of a first lead screw engaged to gears coupled to each row. A second stepper motor tilts the mirror concentrators simultaneously about a second axis by means of a second lead screw coupled to a screw that translates a linkage coupled to each of the mirror concentrators. The first and second stepper motors cooperate to turn the mirror concentrators in a first direction and tilt the mirror concentrators in a second direction simultaneously so that the mirror concentrators track the trajectory of the sun. Such tracking optimizes the reflection of the sun's rays by the mirror concentrators to maximize photovoltaic energy generation of solar cells.

In a first preferred embodiment, the system of the invention is disposed inside an enclosure within which is arranged the array of mirror concentrators. One end of the enclosure includes the first and second stepper motors and driving gears. The top of the enclosure includes a cover made of glass or other light transmissive material. The enclosure provides a sealed environment for the array of mirror concentrators and the turning and tilting mechanisms to protect these from rain, dust, hail, falling leaves and other environmental hazards. The enclosure may be disposed on building structures, for instance, on a south-facing rooftop. By making the mirror concentrators relatively small, the enclosure may be made thin so as to be useful in residential applications. In such applications, the array of mirror concentrators may include a 10×20 array.

In a second preferred embodiment, the array of mirror concentrators may be attached to a fixed framework support. The fixed framework support includes linkages for tilting the mirror concentrators, a first housing for containing the first and second stepper motors, lead screws, gears and linkages and a second housing providing rotation support structures. First and second housings protect these components from the weather. The fixed framework support is tilted so that the mirror concentrators attached thereto face the sun and may be fixed on the top of buildings or on the ground. The mirror concentrators have a relatively larger size of about 1 to 3 feet in diameter to allow for turning and tilting by the stepper motors. The mirror concentrators are preferably separated one from the other to provide for open space therebetween. This arrangement allows for wind to flow between the mirror concentrators to thereby reduce wind drag on the roof or other supporting structure.

The mirror concentrators include an array of flat mirrors made of glass coated on a backside with silver or other reflective material. Sunlight is transmitted through the glass and reflected by the silver surface toward a solar cell. The mirror concentrators further include a structured sheet metal or molded plastic dish that carries the array of flat mirrors and provides protection to the array. The dish provides a means for mounting the mirror concentrators to the turning and tilting mechanisms.

In accordance with one aspect of the invention, a system for simultaneously turning and tilting an array of mirror concentrators includes a first stepper motor operable to drive a first lead screw coupled to each row of the array of mirror concentrators, the rotation of the first lead screw simultaneously turning the rows of the array about a first axis thereof, and a second stepper motor operable to drive a second lead screw coupled to each mirror concentrator of each row, the rotation of the second lead screw simultaneously tilting each mirror concentrator about a second axis thereof

In accordance with another aspect of the invention, a system for simultaneously turning and tilting an array of mirror concentrators includes a first stepper motor operable to drive a first lead screw coupled to each row of the array of mirror concentrators, the rotation of the first lead screw simultaneously turning the rows of the array about a first axis thereof, a second stepper motor operable to drive a second lead screw coupled to each mirror concentrator of each row, the rotation of the second lead screw simultaneously tilting each mirror concentrator about a second axis thereof, and an enclosure within which is disposed the array of mirror concentrators, the first and second stepper motors and the first and second lead screws.

In accordance with yet another aspect of the invention, a system for simultaneously turning and tilting an array of mirror concentrators includes a first stepper motor operable to drive a first lead screw coupled to each row of the array of mirror concentrators, the rotation of the first lead screw simultaneously turning the rows of the array about a first axis thereof, a second stepper motor operable to drive a second lead screw coupled to each mirror concentrator of each row, the rotation of the second lead screw simultaneously tilting each mirror concentrator about a second axis thereof, and a fixed framework support having linkages for tilting each of the mirror concentrators, a first housing for containing the first and second stepper motors, first and second lead screws and a second housing for providing rotation support structures.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of design and to the sequence of steps and processes set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures and methods for carrying out the several purposes of the present invention. It is important, therefore, that the claims be regarded as including such equivalent structures and methods insofar as they do not depart from the spirit and scope of the present invention.

### BRIEF DESCRIPTION OF THE DRAWINGS

In the drawings:

FIG. 1 is a schematic representation of a system for simultaneously turning and tilting an array of mirror concentrators in accordance with the invention;

FIG. 2 is a top plan view of the system of FIG. 1;

FIG. 3 is a partial side elevation view of the system of FIG. 1

FIG. 4 is a cross sectional view showing two mirror concentrators in accordance with the invention;

FIG. 5 is a schematic representation illustrating the two arrays of mirror concentrators disposed on a roof of a house in accordance with the invention; and

FIG. 6 is a schematic representation illustrating an array of mirror concentrators disposed on a fixed framework support in accordance with the invention.

### DETAILED DESCRIPTION OF THE INVENTION

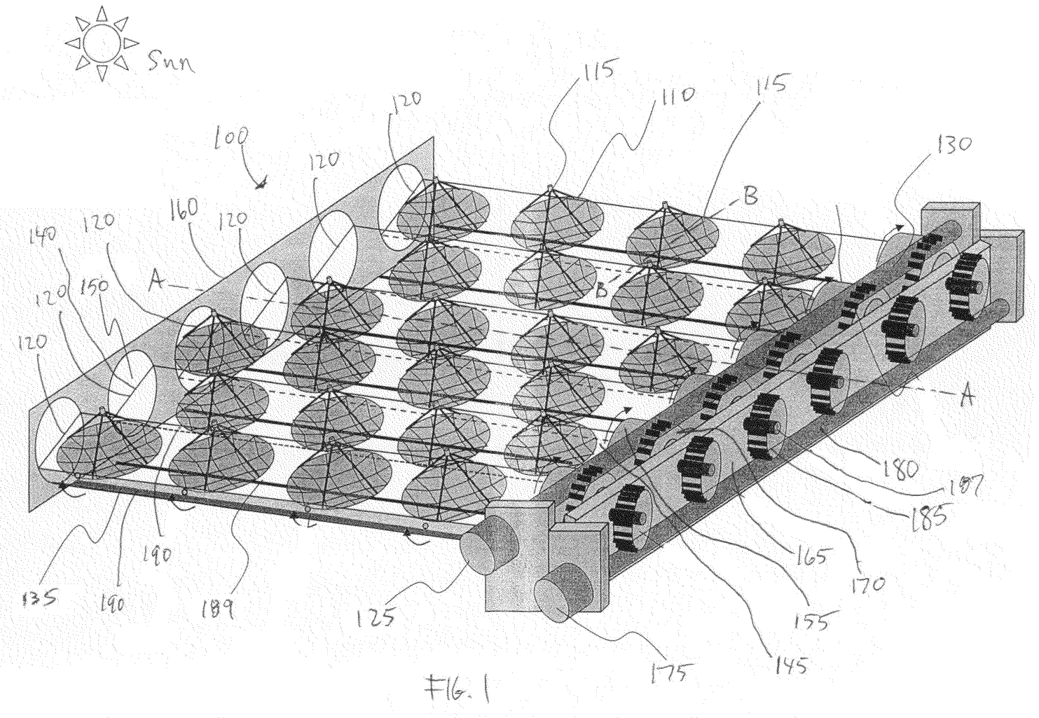

A system for simultaneously turning and tilting an array of mirror concentrators generally designated 100 is schematically represented in FIG. 1. The system 100 provides for tracking of the sun across the sky in order to keep an array 105 of mirror concentrators 110 aligned with the rays of the sun. Each mirror concentrator 110 is aligned toward the sun and includes an array of flat mirrors (not shown) disposed and aligned to reflect the rays of the sun onto a solar cell 115 as described in co-owned and co-pending patent application Ser. No. 60/997,253 filed on Oct. 1, 2007, the complete disclosure of which is incorporated herein in its entirety. The array 105 of mirror concentrators 110 is shown including six rows 120 having four mirror concentrators 110 each but arrays having different configurations are within the scope of the invention.

Each row 120 of mirror concentrators 110 is turned about a first axis A-A thereof by a first stepper motor 125 coupled to a first lead screw 130 that is in turn coupled to a plurality of half tube structures 135 within which the mirror concentrators 110 comprising each row are spacedly attached. Each half tube structure 135 is coupled to a rotating wheel 150 at a first end 140 thereof and to a rotating tube 155 at a second end 145 thereof. The rotating wheel 150 is rotatably disposed within a first wall 160 of the array 105 and the rotating tube 155 is rotatably disposed within a second wall 165 of the array 105. Each rotating tube 155 is coupled to a gear 170 engaged to the first lead screw 130. Rotation of the first lead screw 130 rotates the gear 170 that in turn rotates the rotating tube 155 to provide 180 degrees of rotation to each row 120 as the sun traverses the sky. Each of the mirror concentrators 110 is thus turned simultaneously.

To achieve tilting of the mirror concentrators 110, a second stepper motor 175 is coupled to a second lead screw 180 that is in turn coupled to gears 185. Each gears 185 is in turn coupled to a fine screw 187 coupled to a linkage 189 attached to each mirror concentrator 110 of each row 120 as further described herein. Each mirror concentrator 110 is pivotally attached to opposite rims 190 of a corresponding half tube structure 135. Translation of the linkages 189 is operable to simultaneously tilt the attached mirror concentrators 110 about an axis B-B of each mirror concentrator 110. Axes A-A and B-B are disposed orthogonally one to the other.

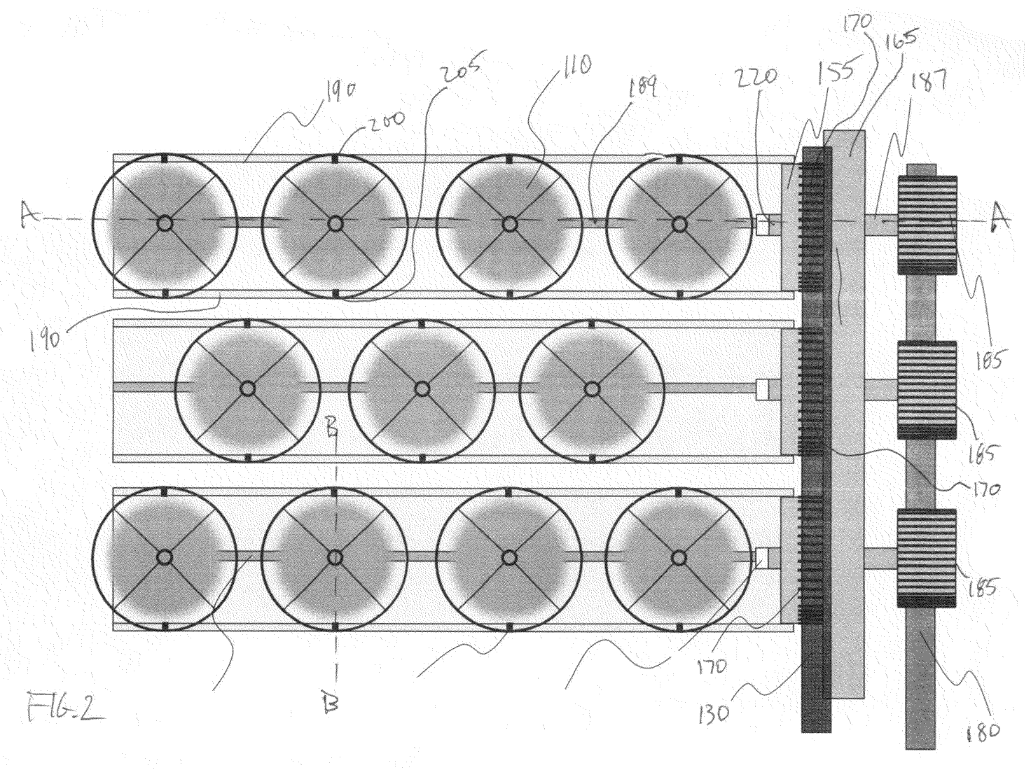

With reference to FIG. 2, the plurality of mirror concentrators 110 are shown facing up. Each mirror concentrator 110 is pivotally attached to the opposite rims 190 at pivot points 200 and 205. Linkages 189 are coupled to the bottoms of each mirror concentrator 110 and to the fine screw 187 coupled to each gear 185 by means of an off axis linkage 220. Rotation of the second lead screw 180 is operable to tilt the mirror concentrators 110 about axis B-B while rotation of the first lead screw 130 is operable to turn the mirror concentrators 110 about axis A-A.

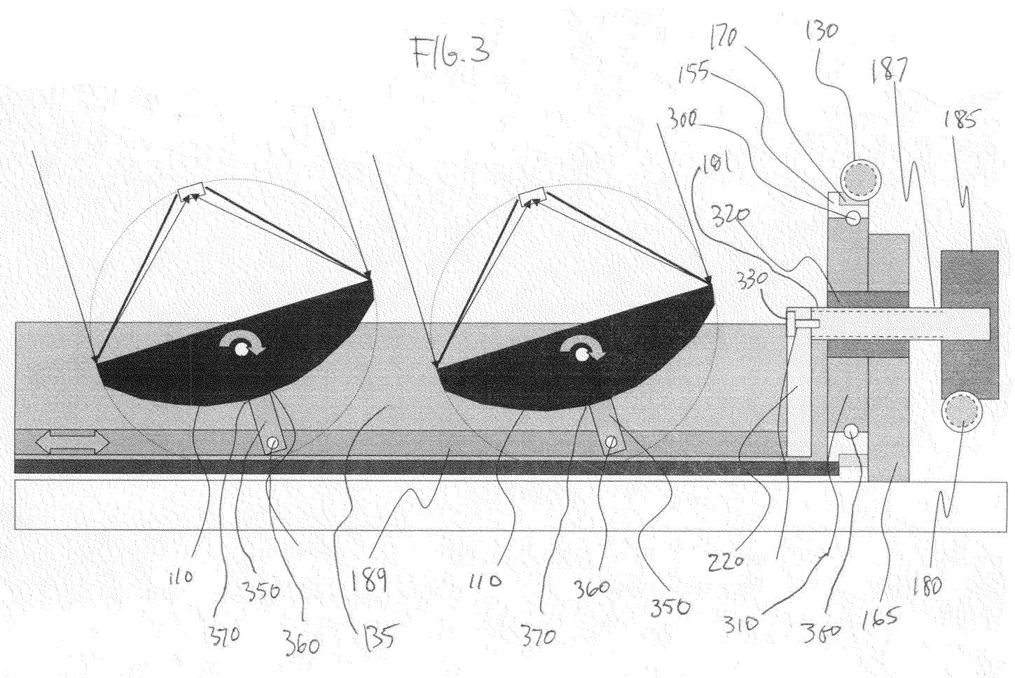

FIG. 3 illustrates the turning and tilting mechanisms of the invention with more particularity. Rotation of the first lead screw 130 drives the gear 170 that in turn rotates the rotating tube 155 smoothly on a set of bearings 300. A bearing inner support 310 is attached to the second wall 165. Rotation of the second lead screw 180 drives the gear 185 that in turn rotates the fine screw 187 in and out of a female screw guide 320 disposed in the second wall 165 and extending through the bearing inner support 310. An end 181 of the fine screw 187 is attached to the off axis linkage 220 by means of a round holder 330. Round holder 330 allows the fine screw 187 to freely rotate relative to the off axis linkage 220. The off axis linkage 220 is attached to the linkage 189. Each mirror concentrator 110 is spacedly and pivotally attached to the linkage 189 at a pivot point 360 by means of a second linkage 350 attached to a bottom portion 370 of the mirror concentrator 110. Rotation of the second lead screw 180 tilts each of the mirror concentrators 110 about the axis B-B (FIG. 2).

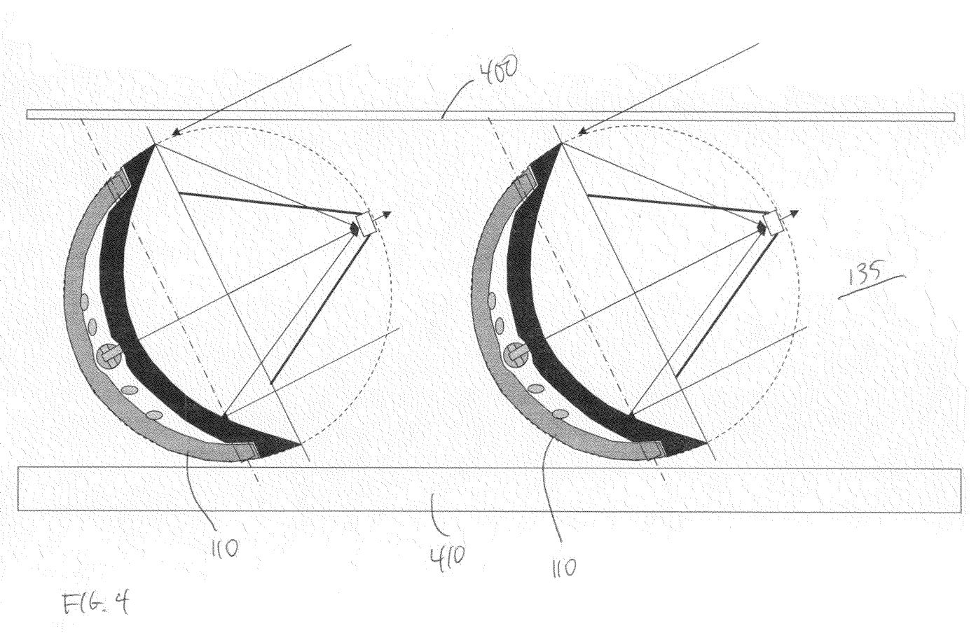

FIG. 4 illustrates rotation of two mirror concentrators 110 within the half tube structure 135. Half tube structure 135 is shown covered by a transparent top window cover 400 and is supported by a base plate 410.

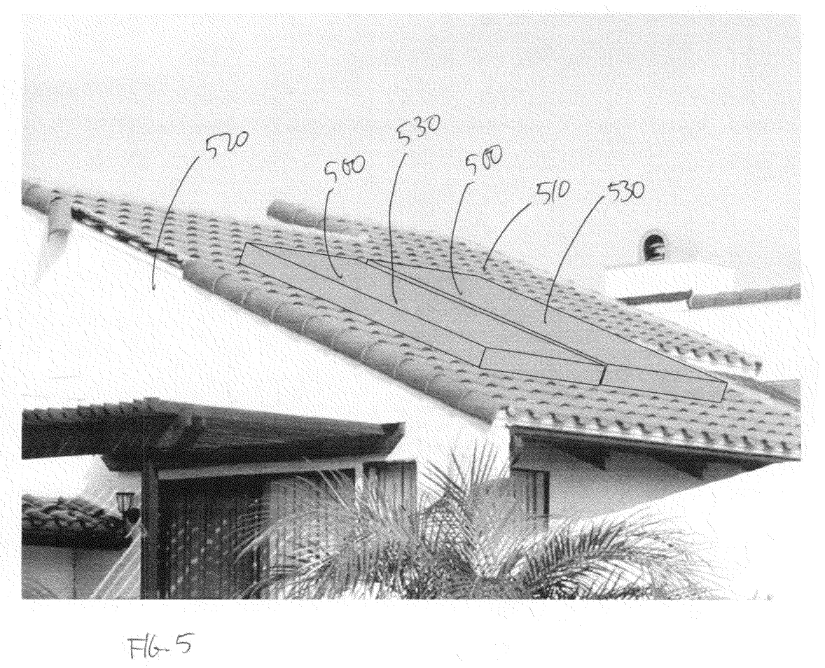

With reference to FIG. 5, two solar concentrator enclosures 500 are shown disposed on a slanted roof 510 of a structure 520. The top of the enclosures 500 includes a cover 530 made of glass or other light transmissive material.

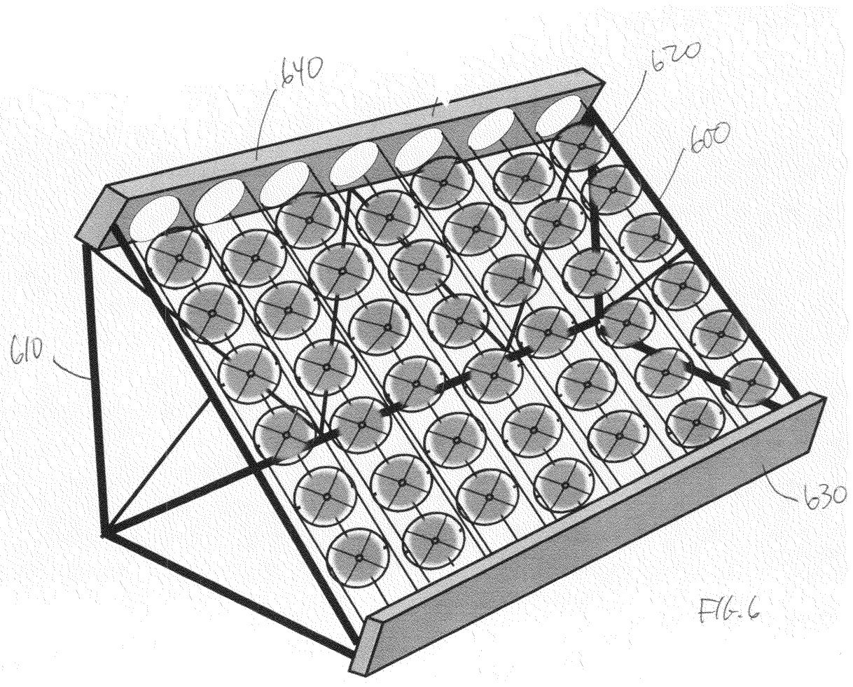

FIG. 6 shows an array of solar concentrators 600 disposed on a fixed framework support 610. The fixed framework support 610 includes linkages for tilting the mirror concentrators. The array 600 includes seven rows and each row has six solar concentrators 620. Stepper motors, lead screws, gears and linkages (not shown) may be disposed a first housing 630 and operate to turn and tilt the rows of solar concentrators 620 as previously described. A second housing 640 provides for rotation support structures including the rotating wheels 150.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

I claim:

1. A system for simultaneously turning and tilting an array of mirror concentrators comprising:
a first stepper motor operable to drive a first lead screw coupled to each row of the array of mirror concentrators, the rotation of the first lead screw simultaneously turning the rows of the array about a first axis thereof; and
a second stepper motor operable to drive a second lead screw coupled to each mirror concentrator of each row, the rotation of the second lead screw simultaneously tilting each mirror concentrator about a second axis thereof.

2. The system of claim 1, wherein each row of the array is turned by an equal angle about the first axis thereof by the rotation of the first lead screw.

3. The system of claim 1, wherein each mirror concentrator is turned by an equal angle about the second axis thereof by the rotation of the second lead screw.

4. The system of claim 1, wherein each row of the array comprises a half tube structure within which the mirror concentrators comprising each row are spacedly and pivotally attached.

5. The system of claim 4, wherein each half tube structure is coupled to a rotating wheel at a first end thereof and to a rotating tube at a second end thereof, the rotating wheel being rotatably disposed within a first wall of the array and the rotating tube being rotatably disposed within a second wall of the array, the rotating tube being coupled to a gear engaged to the first lead screw.

6. The system of claim 1, wherein the second lead screw is coupled to a plurality of gears each of which is in turn coupled to a fine screw, rotation of each fine screw being operable to translate a linkage attached thereto and to tilt each mirror concentrator attached to each linkage.

7. The system of claim 6, wherein an end of each fine screw is attached to an off axis linkage by means of a round holder that allows each fine screw to freely rotate relative to each off axis linkage, each off axis linkage being attached to each linkage.

8. The system of claim 6, wherein each mirror concentrator of each row is spacedly and pivotally attached to each linkage at a pivot point by means of a second linkage attached to a bottom portion of each mirror concentrator.

9. A system for simultaneously turning and tilting an array of mirror concentrators comprising:
a first stepper motor operable to drive a first lead screw coupled to each row of the array of mirror concentrators, the rotation of the first lead screw simultaneously turning the rows of the array about a first axis thereof;
a second stepper motor operable to drive a second lead screw coupled to each mirror concentrator of each row, the rotation of the second lead screw simultaneously tilting each mirror concentrator about a second axis thereof; and
an enclosure within which is disposed the array of mirror concentrators, the first and second stepper motors and the first and second lead screws.

10. The system of claim 9, wherein a top of the enclosure comprises a light transmissive material.

11. The system of claim 10, wherein the light transmissive material comprises glass.

12. The system of claim 9, wherein each row of the array is turned by an equal angle about the first axis thereof by the rotation of the first lead screw.

13. The system of claim 9, wherein each mirror concentrator is turned by an equal angle about the second axis thereof by the rotation of the second lead screw.

14. The system of claim 9, wherein each row of the array comprises a half tube structure within which the mirror concentrators comprising each row are spacedly and pivotally attached.

15. The system of claim 14, wherein each half tube structure is coupled to a rotating wheel at a first end thereof and to a rotating tube at a second end thereof, the rotating wheel being rotatably disposed within a first wall of the array and the rotating tube being rotatably disposed within a second wall of the array, the rotating tube being coupled to a gear engaged to the first lead screw.

16. A system for simultaneously turning and tilting an array of mirror concentrators comprising:
a first stepper motor operable to drive a first lead screw coupled to each row of the array of mirror concentrators, the rotation of the first lead screw simultaneously turning the rows of the array about a first axis thereof;
a second stepper motor operable to drive a second lead screw coupled to each mirror concentrator of each row, the rotation of the second lead screw simultaneously tilting each mirror concentrator about a second axis thereof; and
a fixed framework support having linkages for tilting each of the mirror concentrators, a first housing for containing the first and second stepper motors, first and second lead screws and a second housing for providing rotation support structures.

17. The system of claim 16, wherein each row of the array is turned by an equal angle about the first axis thereof by the rotation of the first lead screw

18. The system of claim 16, wherein each mirror concentrator is turned by an equal angle about the second axis thereof by the rotation of the second lead screw

19. The system of claim 16, wherein each row of the array comprises a half tube structure within which the mirror concentrators comprising each row are spacedly and pivotally attached.

20. The system of claim 19, wherein each half tube structure is coupled to a rotating wheel at a first end thereof and to a rotating tube at a second end thereof, the rotating wheel being rotatably disposed within a first wall of the array and the rotating tube being rotatably disposed within a second wall of the array, the rotating tube being coupled to a gear engaged to the first lead screw.
